(19) United States
(12) Patent Application Publication
(10) Pub. No.: US 2006/0051547 A1
(43) Pub. Date: Mar. 9, 2006

(54) Air duct hose and manufacturing method thereof

(75) Inventors: Heyung-Duk Lim, Seoul (KR); Hee-In Lee, Incheon (KR)

Correspondence Address: YOUNG & THOMPSON, 745 SOUTH 23RD STREET, 2ND FLOOR, ARLINGTON, VA, 22202, US

(73) Assignee: HYUPJUNG CO., LTD., INCHEON (KR)

(21) Appl. No.: 10/935,222

(22) Filed: Sep. 8, 2004

(51) Int. Cl. F16L 11/04; B32B 37/00

(52) U.S. Cl. 428/36.91; 156/60

(57) ABSTRACT

Provided is a method of manufacturing an air duct hose. The method includes the steps of: inserting a first adhesive film formed of a resin layer between a heat insulator and a first aluminum foil to attach the first aluminum foil to the heat insulator; inserting a second adhesive film formed of a resin layer between the heat insulator and a second aluminum foil to attach the second aluminum foil to the heat insulator; and coating an adhesive on one side surface of the nonflammable member in a state where the first and second aluminum foils are layered at the interior and the exterior of the heat insulator.

### BACKGROUND OF THE INVENTION

1. Field of the Invention

The present invention relates to an air duct hose and a method of manufacturing the same, and more particularly, to an air duct hose having a fire resistance and a fire retardancy against a high temperature of flame and gas, and minimizing the generation of toxic gas at the time of firing.

2. Description of the Related Art

An air duct hose for exhaustion is selectively used according to a use purpose. In case where an engine displacement is large and a pressure is at a high level, an iron air duct hose is being used. However, in case where the engine displacement is small and the pressure is at a low level, an aluminum air duct hose is being used.

As shown in FIGS. 1 and 2, the aluminum air duct hose 10 is comprised of a tube body including two sheets of aluminum foils 12 and 13 overlapped at an interior and an exterior of a heat insulator 11; and a reinforcing iron core 14 consecutively helically inserted to be extended lengthwise. The aluminum air duct hose has the following drawbacks.

First, since the aluminum air duct hose is formed of a thin plate, it has a weak tensile strength or shear strength. Accordingly, if the aluminum air duct hose repeatedly performs a lengthwise contractile movement along a shape of the reinforcing iron core, the aluminum air duct hose is destroyed at a folded portion, thereby not only leaking a fluid material, but also reducing a product life.

Second, since a cool or hot air of exhaustion gas passing through the air duct hose is transmitted to the external through a thin tube body, indoor air duct hose unintentionally causes a variation of an indoor temperature, and a temperature difference causes a secondary energy loss. While the cool or hot air of the air duct hose is transferred, a heat exchange is generated such that a temperature of an airflow flowing the air duct hose cannot be maintained in its original state, thereby causing a difficulty in controlling a temperature.

Third, a manufacturing method of the air duct hose is complex. In other words, a failure can be generated when two sheets of aluminum foils 12 and 13 are adhered to the interior and the exterior of the heat insulator 11. If air is introduced into an adhesion portion of the aluminum foils 12 and 13 and the heat insulator 11, an outer surface of the adhesion portion is not only protruded, but also is easily torn due to an external friction. Specifically, the manufacturing method is complex due to its steps of: cylindrically winding the inner aluminum foil 12; winding the reinforcing iron core 14 at an outer surface of the inner aluminum foil; and cylindrically winding the outer aluminum foil 13 at an exterior of the reinforcing iron core 14.

Fourth, the air duct hose having the aluminum foils 12 and 13 is easily ignited due to a high heat, thereby causing a fire or discharging a contaminant.

Unlike the air duct hose comprised of the tube body including the two sheets of aluminum foils 12 and 13 overlapped with each other and a reinforcing iron core 14 consecutively helically inserted to extend lengthwise, another conventional air duct hose is disclosed. In the conventional air duct hose, a polyester metalizing film is cut in a predetermined width and has one surface on which an adhesive is coated. After a duct film is two-folded, a helical type iron core is wound using the adhesive coated on the duct film such that the iron cores are piped and connected therebetween.

The air duct hose has an advantage in that it can be easily carried or in safekeeping due to a good foldness. Even though the air duct hose is damaged and holed, the external polyester metalizing film can prevent a leakage of the exhaustion gas to have a flame proof to some degrees. However, the air duct hose cannot endure a high heat. Further, the polyester metalizing film is melted by fire, and a toxic gas containing a large content of toxic material is generated for combustion.

In the meanwhile, as shown in FIGS. 1 to 3, an air duct hose and a manufacturing method of the air duct hose are disclosed in Korean patent publication number No. 2003-0083470. The air duct hose 10 is constructed by winding a nonflammable member 15. The nonflammable member 15 has the heat insulator 11 between aluminum foils 12 and 13 provided at front and rear surfaces of the air duct hose having a helical type reinforcing iron core 14 formed within a tube body. The nonflammable member 15 is divided into a layered portion (A) at both sides, and a bent portion (B) at its center. The layered portion (A) is two-folded and the bent portion (B) is one-folded. An adhesive layer is formed and the reinforcing iron core 14 is attached at an overlapped portion of the layered portion (A). In the manufacturing method of the air duct hose, the band type nonflammable member 15 having a predetermined width is helically wound and the adhesive is coated on the overlapped portion of the nonflammable member 15. After that, the helical type reinforcing iron core is disposed to complete the cylindrical air duct hose.

The air duct hose has the heat insulator formed between the aluminum foils to have a good thermal endurance and thermal insulation and improve the destruction or deformation of the air duct hose, thereby ensuring a safety and extending the product life. Since the air duct hose can be manufactured while the nonflammable member is wound, a simple manufacture can be made.

However, the manufacturing method of the air duct hose has a disadvantage in that too many processes are required to manufacture the nonflammable member 15 as shown in FIG. 4, and in that the adhesive or other aromatics used, as ignitable or flammable materials, in the manufacture of the nonflammable member cause the ignition to be weak against a heat. Accordingly, the air duct hose has a drawback in that it has a low reliability as the nonflammable member since there is a large possibility of ignition by flame generated at an interior and an exterior of the air duct hose.

### SUMMARY OF THE INVENTION

Accordingly, the present invention is directed to an air duct hose and a method of manufacturing the same that substantially obviate one or more problems due to limitations and disadvantages of the related art.

An object of the present invention is to provide a method of manufacturing an air duct hose through an easy and simple process.

Another object of the present invention is to provide a method of manufacturing an air duct hose at a low cost.

A further another object of the present invention is to provide an air duct hose having a low ignition possibility to provide a high reliability.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method of manufacturing an air duct hose having a nonflammable member having first and second aluminum foils provided at an interior and an exterior of a heat insulator; and a reinforcing structure having a reinforcing iron core helically wound at centers of adhesion parts at which the nonflammable members are consecutively overlapped at one ends, the method including the steps of: inserting a first adhesive film formed of a resin layer, which contains a flame proofing agent at one side surface of the heat insulator, between the heat insulator and the first aluminum foil to attach the first aluminum foil to the heat insulator; inserting a second adhesive film formed of a resin layer, which contains a flame proofing agent at the other side surface of the heat insulator, between the heat insulator and the second aluminum foil to attach the second aluminum foil to the heat insulator; and coating an adhesive on one side surface of the nonflammable member in a state where the first and second aluminum foils are layered at the interior and the exterior of the heat insulator.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 a view illustrating a structure of a general air duct hose;

FIG. 2 is a cross-sectional view of FIG. 1;

FIG. 3 is a reference view illustrating a method of manufacturing an air duct hose;

FIG. 4 is views illustrating a process of manufacturing a conventional nonflammable member of an air duct hose;

FIG. 5 is a laminar view illustrating an attachment process of an air duct hose according to a preferred embodiment of the present invention;

FIG. 6 is a view illustrating a detailed structure of an adhesive film according to a preferred embodiment of the present invention;

FIG. 7 is a laminar view illustrating a nonflammable member used as a perform of an air duct hose according to a preferred embodiment of the present invention;

FIG. 8 is a view illustrating a process of manufacturing a nonflammable member according to a preferred embodiment of the present invention;

FIG. 9 is a view illustrating a product appearance of an air duct hose according to a preferred embodiment of the present invention; and

FIG. 10 is a sectional view illustrating a construction of an air duct hose according to a preferred embodiment of the present invention.

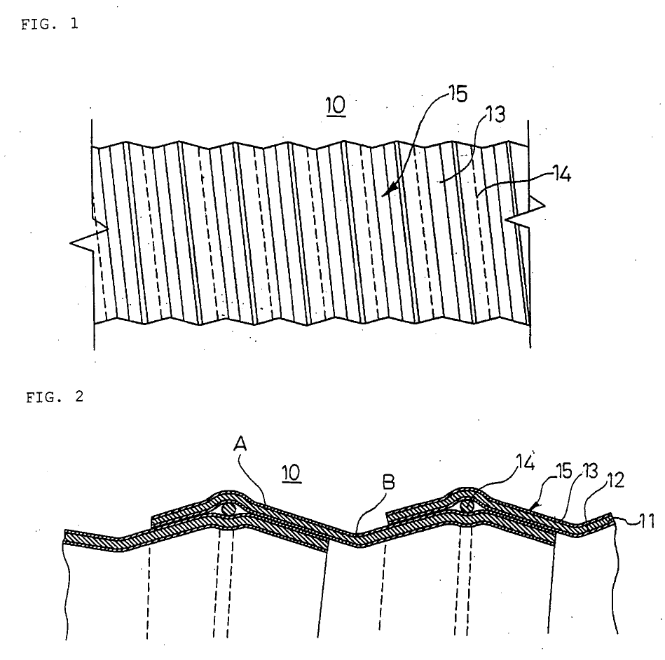

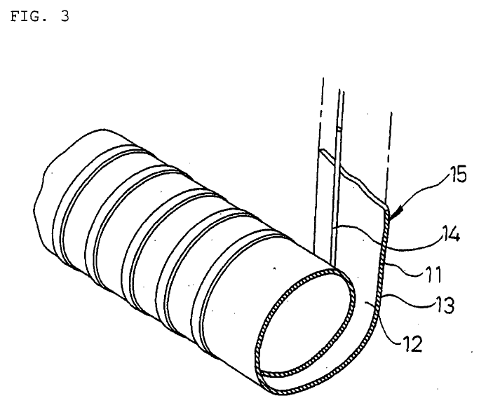

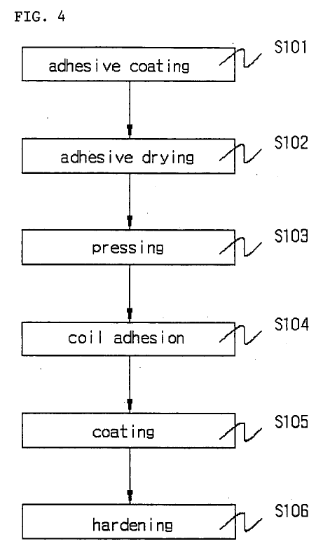

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

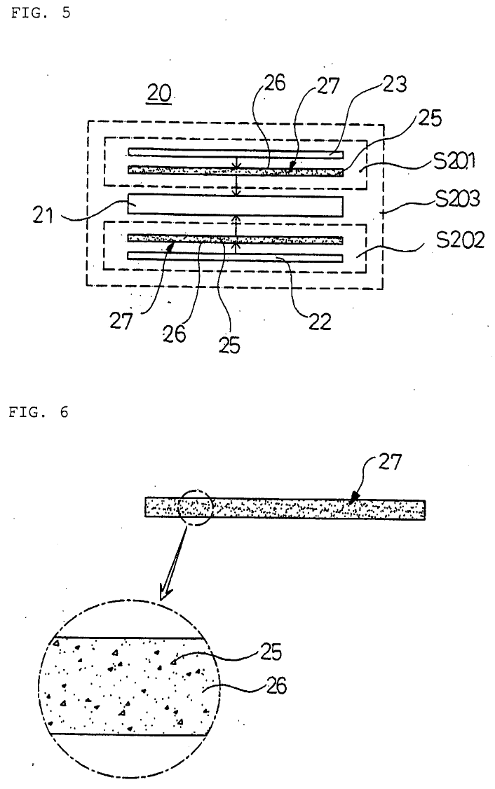

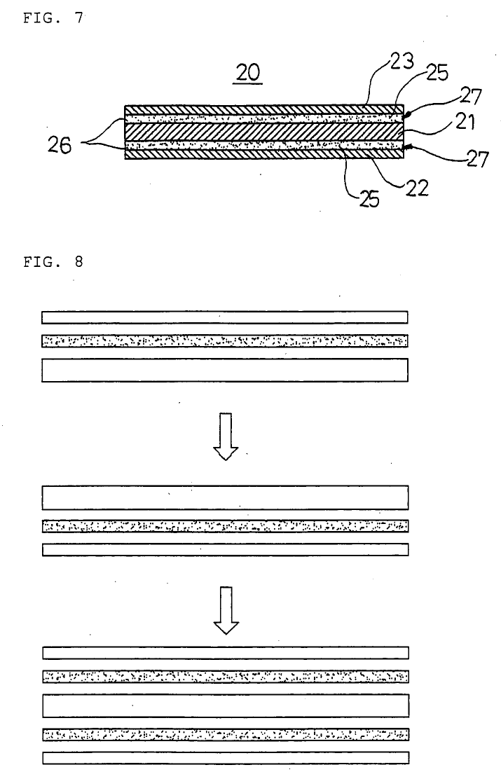

A structure of an air duct hose and a method of manufacturing the air duct hose according to the present invention are illustrated as in FIGS. 5 to 10.

The air duct hose is manufactured using a nonflammable member 20 as a perform, and the nonflammable member 20 is manufactured through first to third processes as shown in FIGS. 5 and 8 as follows.

The inventive air duct hose is manufactured as follows. The nonflammable member 20 is constructed to have aluminum foils 22 and 23 provided at an interior and an exterior of a heat insulator 21. After that, the nonflammable members 20 are consecutively overlapped at one ends to have adhesion parts, and then a reinforcing iron core 14 is helically wound at centers of the adhesion parts to complete the air duct hose 24 with a reinforcing structure.

The nonflammable member 20 is manufactured through first to third steps (S201, S202 and S203).

In the first step (S201), an adhesive film 27 formed of a resin layer 26, which contains a flame proofing agent 25 at one side surface of the heat insulator 21, is inserted between the heat insulator 21 and the aluminum foil 23 to attach the aluminum foil 23 to the heat insulator 21. In the second step (S202), an adhesive film 27 formed of a resin layer 26, which contains a flame proofing agent 25 at the other side surface of the heat insulator 21, is inserted between the heat insulator 21 and the aluminum foil 22 to attach the aluminum foil 22 to the heat insulator 21. In the third step (S203), an adhesive is coated on one side surface of the nonflammable member in a state where the aluminum foils 22 and 23 are layered at the interior and the exterior of the heat insulator 21 through the first and second steps (S201) (S202).

Further, in the first and second steps (S201) (S202), if the adhesive films 27 are inserted between the heat insulator 21 and the aluminum foils 22 and 23 to compress the heat insulator 21 and the aluminum foils 22 and 23, the resin layer 26 of the adhesive film 27 is fused to adhere the heat insulator 21 to the aluminum foils 22 and 23.

Furthermore, the adhesive film 27 attaches the heat insulator 21 to the aluminum foils 22 and 23 by using a thermal fusion of the resin layer 26, and has the resin layer 26 containing the flame proofing agent 25. The flame proofing agent 25 is contained at an amount of about 20 to 40%. The flame proofing agent 25 is not fused unlike the resin layer 26 of the adhesive film 27. Since a fusion strength of the resin layer 26 is varied depending on a content of the flame proofing agent 25, it is required to control the content of the flame proofing agent 25. According to the present invention, the content of the flame proofing agent 25 is controlled within a range of about 20 to 40% in the adhesive film 27 having the resin layer 26 that is a basic shaping material. In this content range, a fusion function of the adhesive film 27 is maintained while a flame proofing function of the flame proofing agent 25 is stabilized.

As the flame proofing agent 25 of the adhesive film 27, a natural particle such as a crushed-stone powder can be selectively used. The natural particle does not have an affinity to or a chemical reaction with the resin layer 26 of the adhesive film 27, and does not almost have a thermal variation. When the resin layer 26, in which the flame proofing agent 25 such as the crushed-stone powder is previously evenly distributed, is fused by flame, the flame proofing agent 25 performs a function of a fire retardancy against ignition, thereby suppressing ignition.

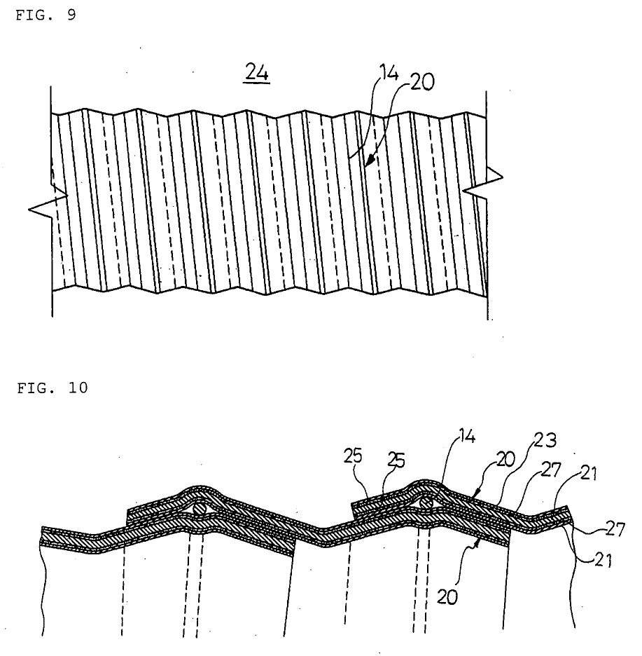

The air duct hose manufactured using the nonflammable member 20 is shown in FIGS. 9 and 10.

The inventive air duct hose 24 includes the nonflammable member 20 having the aluminum foils 22 and 23 provided at the interior and the exterior of the heat insulator 21; and the reinforcing structure having the reinforcing iron core 14 helically wound at the centers of the adhesion parts at which the nonflammable members 20 are consecutively overlapped at one ends. The air duct hose 24 includes, as main parts, the nonflammable members 20 overlapped and adhered to each other to have the adhesion parts; and the reinforcing iron core 14 wounded at the centers of the adhesion parts. The nonflammable members 20 include the heat insulator 21; the aluminum foils 22 and 23 attached at the interior and the exterior of the heat insulator 21; the adhesive films 27 interposed between the heat insulator 21 and the aluminum foils 22 and 23 to adhere the heat insulator 21 and the aluminum foils 22 and 23 due to the fusion of the resin layer 26; and the flame resistant agent 25 contained in the resin layer 26 of the adhesive film 27 and having, as a main component, the crushed-stone powder with the flame retardancy.

The manufacturing method of the air duct hose, and an effect of the air duct hose using the manufacturing method are described with reference to FIGS. 5 to 10.

FIG. 8 is a view illustrating a method of manufacturing the nonflammable member 20 of the air duct hose according to the present invention.

The adhesive film 27 is a plate-shaped adhesive having the flame proofing agent 25 contained in the resin layer 26. That is, the aluminum foils 22 and 23 are adhered to the interior and the exterior of the heat insulator 21 by the fusion strength.

As the adhesive for adhering the heat insulator and the aluminum foils, which constitute the air duct hose, various adhesives having a fusion resin or a chemical material can be used. However, an excellently functional adhesive does not have flammability, does maintain the fire retardancy, and does not have a thermal deformation or a reaction caused by flame. Accordingly, the present invention previously manufactures the adhesive film 27 having the flame proofing agent 25 contained in the resin layer 26 to maintain the flame retardancy using the flame proofing agent 25. The adhesive film 27 is used to adhere the aluminum foils 22 and 23 to the interior and the exterior of the heat insulator 21, thereby completing the nonflammable member 20.

The inventive manufacturing method of the nonflammable member 20 includes: a first step (S201) of adhering the aluminum foil 23 to one side surface of the heat insulator 21; a second step (S202) of adhering the aluminum foil 22 to the other side surface of the heat insulator 21; and a third step (S203) of coating one side surfaces of the adhered heat insulator 21 and aluminum foils 22 and 23. According to the inventive manufacturing method, the nonflammable member 20 can be simply manufactured. Since the particles such as the crushed-stone powder can be used as the flame proofing agent 25, the nonflammable member 20 can be manufactured at a low cost, and has an excellent flame retardancy.

FIGS. 9 and 10 illustrate the air duct hose 24 having the nonflammable member 20 manufactured according to the present invention.

The aluminum foils 22 and 23 are adhered to the interior or exterior of the heat insulator 21 by the adhesive film 27. Here, the adhesive film 27 maintains an adhesive strength of the heat insulator 21 and the aluminum foils 22 and 23 by using the resin layer 26 while performing a flame proofing function for preventing the ignition caused by the high heat or the flame. That is, since the flame proofing agent 25 is contained in an evenly distributed state of particle to prevent the flammability or the ignition of the resin layer 26, the resin layer 26 has the fire resistance and the fire retardancy against the high heat of flame and gas not to be ignited at the time of discharging the high heat of exhaust gas or firing. Accordingly, the air duct hose can obtain a good thermal insulation, flexibility and elasticity, and a good use safety due to a minimal generation of toxic gas at the time of firing.

As described above, the inventive manufacturing method of the air duct hose use the flame-proofed nonflammable member. The nonflammable member has an effect in that it can be easily and simply manufactured at the low cost, and in that it has functionally the excellent flame retardancy against the flame or the high heat. Further, the inventive air duct hose having the nonflammable member has a characteristic in which the aluminum foils and the heat insulator are firmly adhered to each other and the ignition is not caused by the high heat and the flame.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A method of manufacturing an air duct hose having a nonflammable member having first and second aluminum foils provided at an interior and an exterior of a heat insulator; and a reinforcing structure having a reinforcing iron core helically wound at centers of adhesion parts at which the nonflammable members are consecutively overlapped at one ends, the method comprising the steps of:
inserting a first adhesive film formed of a resin layer, which contains a flame proofing agent at one side surface of the heat insulator, between the heat insulator and the first aluminum foil to attach the first aluminum foil to the heat insulator;
inserting a second adhesive film formed of a resin layer, which contains a flame proofing agent at the other side surface of the heat insulator, between the heat insulator and the second aluminum foil to attach the second aluminum foil to the heat insulator; and
coating an adhesive on one side surface of the nonflammable member in a state where the first and second aluminum foils are layered at the interior and the exterior of the heat insulator.

2. The method according to claim 1, wherein the adhesive films are inserted between the heat insulator and the aluminum foils to compress and adhere the heat insulator and the aluminum foils at a temperature of 200C.

3. The method according to claim 1, wherein the flame proofing agent distributed in the resin layer of the adhesive film is controlled at a content of about 20 to 40%.

4. The method according to claim 1, wherein as the flame-proofing agent, a crushed-stone powder is selected and used.

5. An air duct hose comprising:
nonflammable members overlapped and adhered to each other to have adhesion parts; and
a reinforcing iron core wound at centers of the adhesion parts,
the nonflammable member comprising:
a heat insulator;
aluminum foils attached at an interior and an exterior of the heat insulator; and
adhesive films interposed between the heat insulator and the aluminum foils to adhere the heat insulator and the aluminum foils due to a fusion of a resin layer,
wherein the adhesive film contains a flame resistant agent having, as a main component, a crushed-stone powder with a flame retardancy.
